(19) United States
(12) Patent Application Publication
(10) Pub. No.: US 2015/0185875 A1
(43) Pub. Date: Jul. 2, 2015

(54) CONTROL SYSTEM AND METHOD FOR CONTROLLING USER INTERFACES FOR ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-SHENG LI, Shenzhen (CN); CHIH-SAN CHIANG, New Taipei (TW); GANG TANG, Shenzhen (CN); ZHAO-PING ZHANG, Shenzhen (CN)

(21) Appl. No.: 14/587,107

(22) Filed: Dec. 31, 2014

(30) Foreign Application Priority Data
Dec. 31, 2013 (CN) 201310749152.7

(51) Int. Cl. G06F 3/0346; G06F 3/0484

(52) U.S. Cl. CPC G06F 3/0346; G06F 3/0484

(57) ABSTRACT

A control system and method for controlling user interfaces on an electronic device are provided. The control system includes a processor configured to execute instructions stored in a storage unit to: determine whether a rotation angle of the electronic device is in an angle range; create a rotated user interface group; create a first planar coordinate system on a rotated user interface of the rotated user interface group; define a first region which the rotated user interface is rotated an angle of the rotation angle of the electronic device; create a second planar coordinate system on the rotated user interface group; define a second region which has a same region as that of the first region; and display the contents on the second region.

### CROSS-REFERENCE TO RELATED APPLICATIONS

This application claims priority to Chinese Patent Application No. 201310749152.7 filed on Dec. 31, 2013, the contents of which are incorporated by reference herein.

### FIELD

The subject matter herein generally relates to control systems for controlling user interfaces, and particularly to a control system for controlling user interfaces of electronic devices.

### BACKGROUND

Electronic device may have a display unit which can display a number of user interfaces. A user can operate the electronic device through the user interfaces.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying a control system for controlling user interfaces for the electronic device.

FIG. 2 shows a current user interface displayed on an electronic device running the control system of FIG. 1.

FIG. 3 is an initial user interface group stored in a storage unit of the electronic device of FIG. 2.

FIG. 4 shows a rotated user interface group created by a rotation unit of the control system of FIG. 1.

FIG. 5 shows an electronic device which is rotated an angle relating with a vertical position.

FIG. 6 shows a first planar coordinate system created by a first coordinate defining unit of the control system of FIG. 1.

FIG. 7 shows a rotated user interface group created by a rotation unit, and a second planar coordinate system created by a second coordinate defining unit of the control system of FIG. 1.

FIG. 8 shows the electronic device of FIG. 5 which displays another user interface.

FIG. 9 shows an electronic device which is rotated an angle relating with a vertical position.

FIG. 10 shows a third planar coordinate system created by a first coordinate defining unit of the control system of FIG. 1.

FIG. 11 shows a rotated user interface group created by a rotation unit, and a fourth planar coordinate system created by a second coordinate defining unit of the control system of FIG. 1.

FIG. 12 shows the electronic device of FIG. 9 which displays another user interface.

FIG. 13 is a flowchart of an embodiment of a method for controlling user interfaces for an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have note described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “unit” as used hereinafter, refers to logic embodied in hardware or firmware, or to a collection of software instructions, written in a programming language, such as, for example, Java, C, or assembly. One or more software instructions in the units may be embedded in firmware. It will be appreciated that units may comprise connected logic units, such as gates and flip-flops, and may comprise programmable units, such as programmable gate arrays or processors. The units described herein may be implemented as either software and/or hardware units and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to a control system and method for controlling user interfaces on an electronic device. The control system includes a processor configured to execute instructions stored in a storage unit to: determine whether a rotation angle of the electronic device is in an angle range; create a rotated user interface group; create a first planar coordinate system on a rotated user interface of the rotated user interface group; define a first region which the rotated user interface is rotated an angle of the rotation angle of the electronic device; create a second planar coordinate system on the rotated user interface group; define a second region which has a same region as that of the first region; and display the contents on the second region.

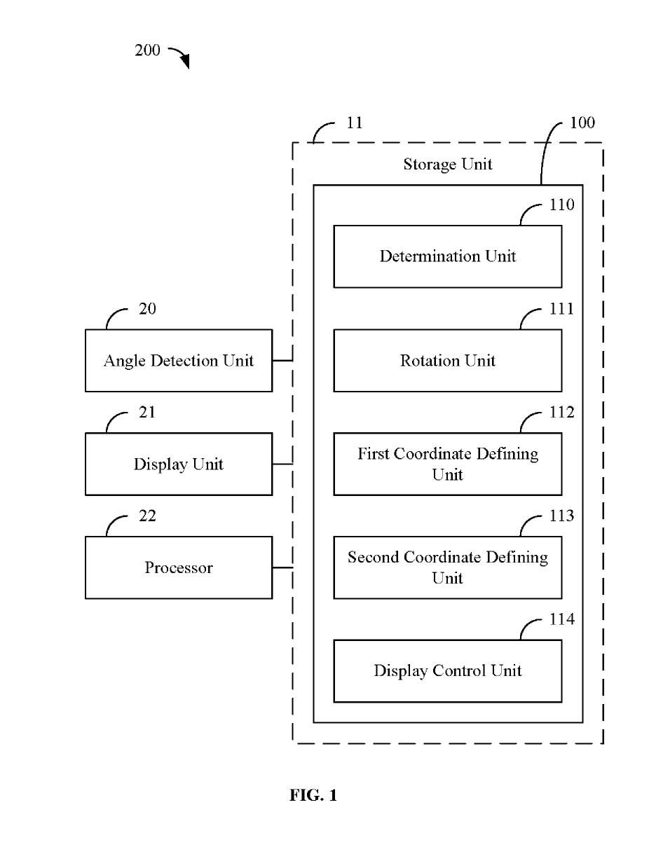

FIG. 1 illustrates an embodiment of an electronic device 200. A control system 100 is applied to the electronic device 200. The electronic device 200 can be a mobile phone or a tablet computer. The electronic device 200 can include an angle detection unit 20 and a display unit 21. The electronic device 200 can also include at least one processor 22 and a storage unit 11. In at least one embodiment, the electronic device 200 includes one processor 22. The processor 22 executes instructions of a plurality of units stored in the storage unit 11. The storage unit 11 can store the control system 100. The control system 100 can include a determination unit 110, a rotation unit 111, a first coordinate defining unit 112, a second coordinate defining unit 113, and a display control unit 114.

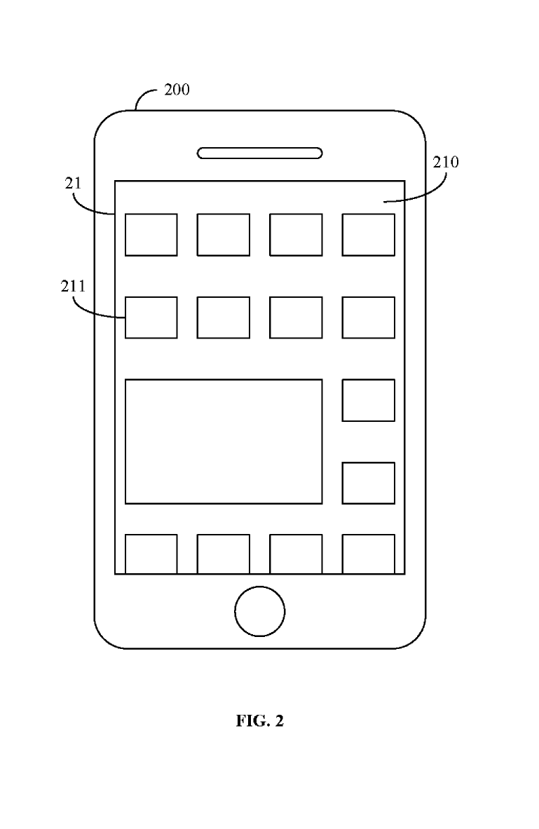

The display unit 21 displays a current user interface 210 as shown in FIG. 2. The current user interface 210 can include a number of items 211 for a user to select.

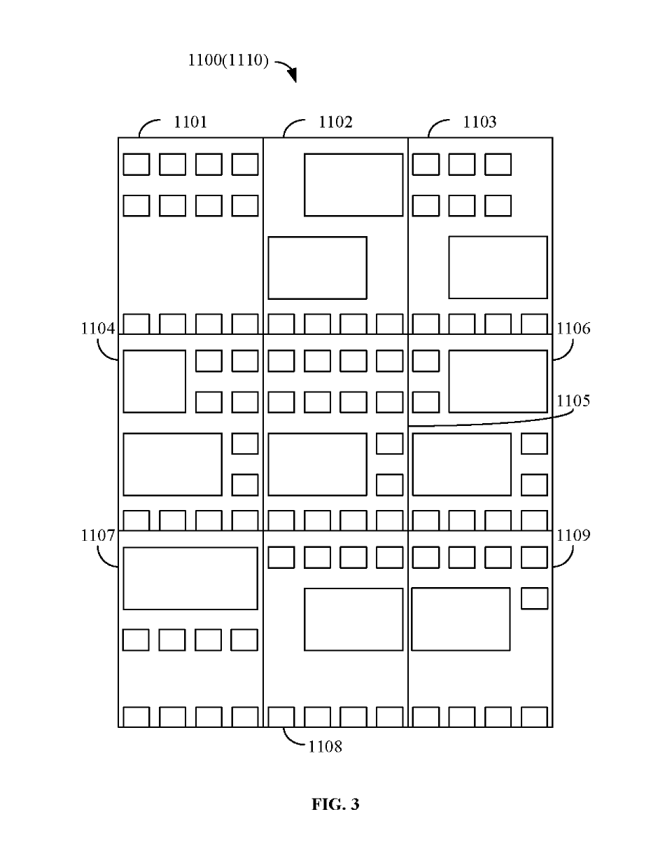

The storage unit 11 can also store an initial user interface group 1100 as shown in FIG. 3. In at least one embodiment, the initial user interface group 1100 can include a first initial user interface 1101, a second initial user interface 1102, a third initial user interface 1103, a fourth initial user interface 1104, a fifth initial user interface 1105, a sixth initial user interface 1106, a seventh initial user interface 1107, an eighth initial user interface 1108 and a ninth initial user interface 1109. Each user interface of the initial user interface group 1100 can replace the current user interface 210 in response to a switch operation by the user. The storage unit 11 can also store position information of each user interface of the initial user interface group 1100. For example, the second initial user interface 1102 is located above the fifth initial user interface 1105, and the fourth user interface 1104 is located at left side of the fifth initial user interface 1105. In at least one embodiment, the display unit 21 displays the fifth initial user interface 1105 as the current user interface 210.

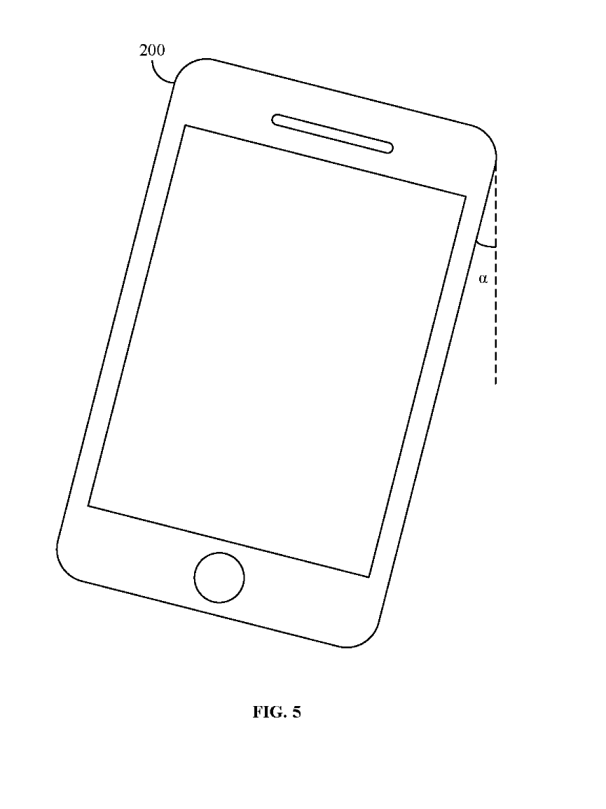

The angle detection unit 20 detects a rotation angle of the electronic device 200 and transmits the detected rotation angle information to the processor 22. The rotation angle α (shown in FIG. 5) is an angle between a vertical axis associated with a current position of the electronic device 200 (e.g. shown in FIG. 5) and a vertical axis associated with a vertical position of the electronic device 200 (e.g. shown in FIG. 2). In at least one embodiment, the angle detection unit 20 can be a gravity sensor, and the gravity sensor detects an acceleration caused by gravity, and the processor 22 calculates the rotation angle according to the acceleration. In other embodiment, the angle detection unit 20 can be a gyro-sensor.

The storage unit 11 stores a number of angle ranges. In at least one embodiment, the number of angle ranges can include a first angle range which includes angles between 0 degrees and 45 degrees, a second angle range which includes angles between 45 degrees and 135 degrees, a third angle range which includes angles between 135 degrees and 225 degrees, a fourth angle range which includes angles between 225 degrees and 315 degrees, and a fifth angle range which includes angles between 315 degrees and 360 degrees.

The determination unit 110 determines which angle range the rotation angle of the electronic device 200 falls within. If the rotation angle falls within the fifth angle range or the first angle range, the rotation unit creates a first rotated user interface group 1110 shown in FIG. 3. The first rotated user interface group 1110 can include a number of rotated user interfaces which are the same as the number and content of the initial user interface group 1100.

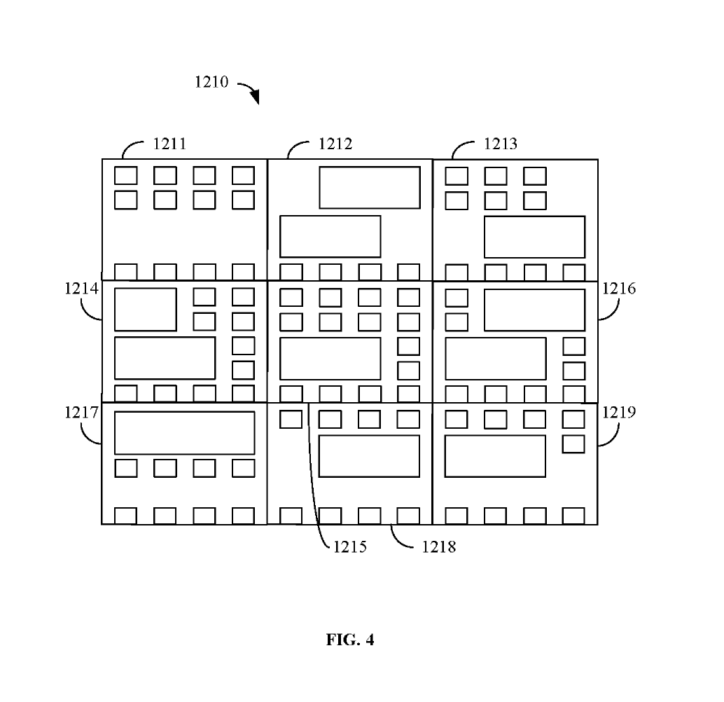

If the rotation angle falls within the second angle range, the rotation unit 111 creates a second rotated user interface group 1210 shown in FIG. 4. In at least one embodiment, the second rotated user interface group 1210 can include a first rotated user interface 1211, a second rotated user interface 1212, a third rotated user interface 1213, a fourth rotated user interface 1214, a fifth rotated user interface 1215, a sixth rotated user interface 1216, a seventh rotated user interface 1217, an eighth rotated user interface 1218 and a ninth rotated user interface 1219. Each user interface of the second rotated user interface group 1210 corresponds to an initial user interface of the initial user interface group 1100, for example, the fourth rotated user interface 1214 corresponds to the fourth initial user interface 1104, and the fifth rotated user interface 1215 corresponds to the fifth initial user interface 1105. Each user interface of the second rotated user interface group 1210 is obtained by rotating a corresponding initial user interface 90 degrees along a rotation direction of the electronic device 200.

If the rotation angle falls within the third angle range, the rotation unit 111 creates a third rotated user interface group (not shown). Each user interface of the third rotated user interface group corresponds to an initial user interface of the initial user interface group 1100, and is obtained by rotating a corresponding initial user interface 180 degrees along the rotation direction of the electronic device 200. The rotation unit 111 creates a fourth rotated user interface group (not shown), if the rotation angle falls within the fourth angle range. Each user interface of the fourth rotated user interface group corresponds to an initial user interface of the initial user interface group, and is obtained by rotating a corresponding initial user interface 270 degrees along a rotation direction of the electronic device 200.

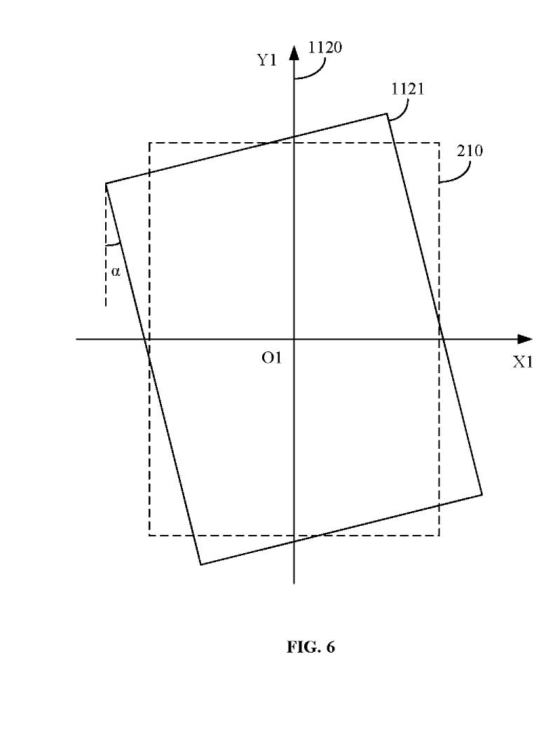

When the rotation angle α of the electronic device 200 falls within the first angle range, the first coordinate defining unit 112 defines a first planar coordinate system 1120 shown in FIG. 6 on the current user interface 210. In at least one embodiment, an origin O1 of the first planar coordinate system 1120 is on the center of the current user interface 210. The axis X1 of the first planar coordinate system 1120 extends along a width direction of the current user interface 210. The axis Y1 of the first planar coordinate system 1120 extends along a length direction of the current user interface 210. The first coordinate defining unit 112 then defines a first region 1121 in the first planar coordinate system 1120. In at least one embodiment, the first region 1121 is obtained by rotating the current user interface 210 an angle α opposite to the rotation direction of the electronic device 200.

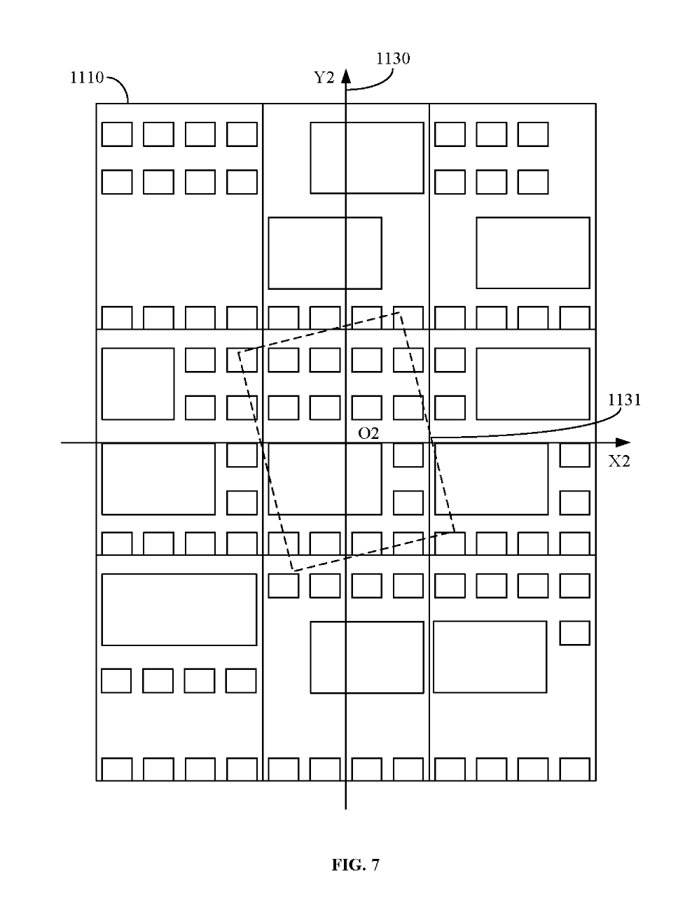

The second coordinate defining unit 113 defines a second planar coordinate system 1130 shown in FIG. 7 on the first rotated user interface group 1110. In at least one embodiment, an origin O2 of the second planar coordinate system 1130 is on the center of the fifth initial user interface 1105, e.g. the current user interface 210. The axis X2 of the second planar coordinate system 1130 extends along a width direction of the fifth initial user interface 1105. The axis Y2 of the second planar coordinate system 1130 extends along a length direction of the fifth initial user interface 1105. The second coordinate defining unit 113 then defines a second region 1131 in the second planar coordinate system 1130. In at least one embodiment, the second region 1131 has a same size as that of the first region 1121.

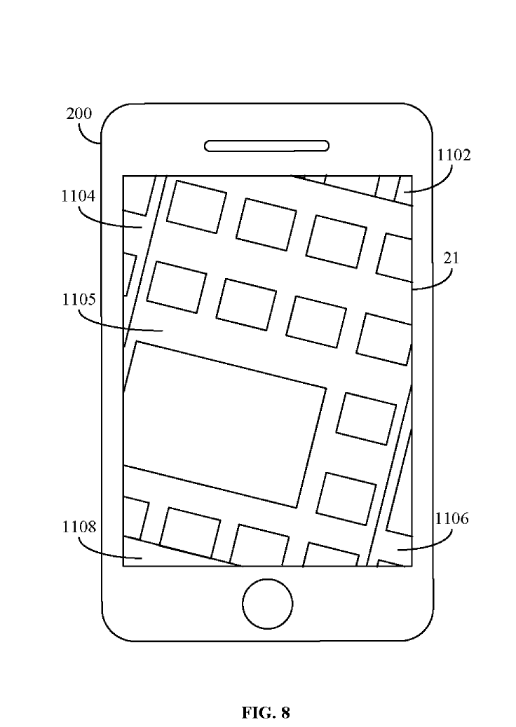

The display control unit 114 controls the display unit 21 to display content of the first rotated user interface group 1110 on the second region 1131 shown in FIG. 8. In at least one embodiment as shown in FIG. 8, the content can include a part of the second initial user interface 1102, a part of the fourth initial user interface 1104, a part of the fifth initial user interface 1105, a part of the sixth initial user interface 1106 and a part of the eighth initial user interface 1108. In an alternative embodiment, the content can include part of other initial user interfaces.

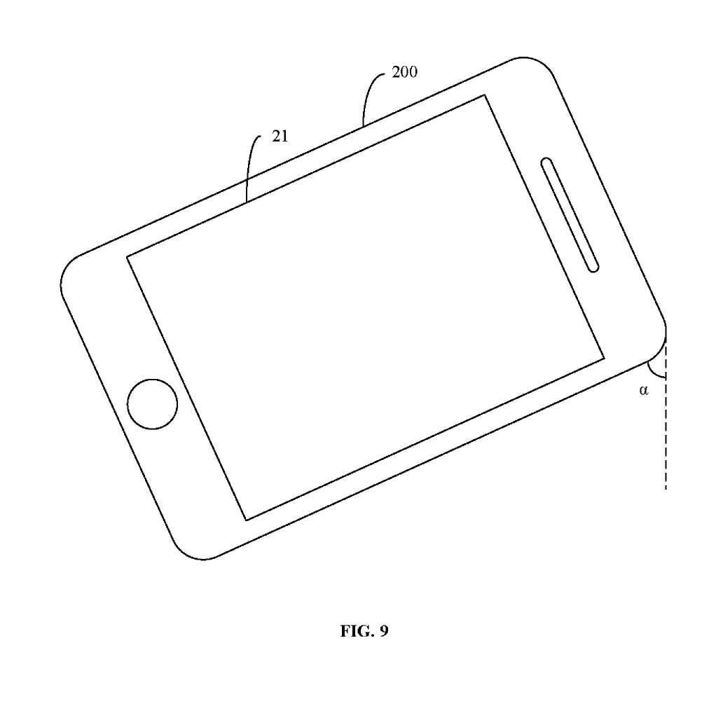

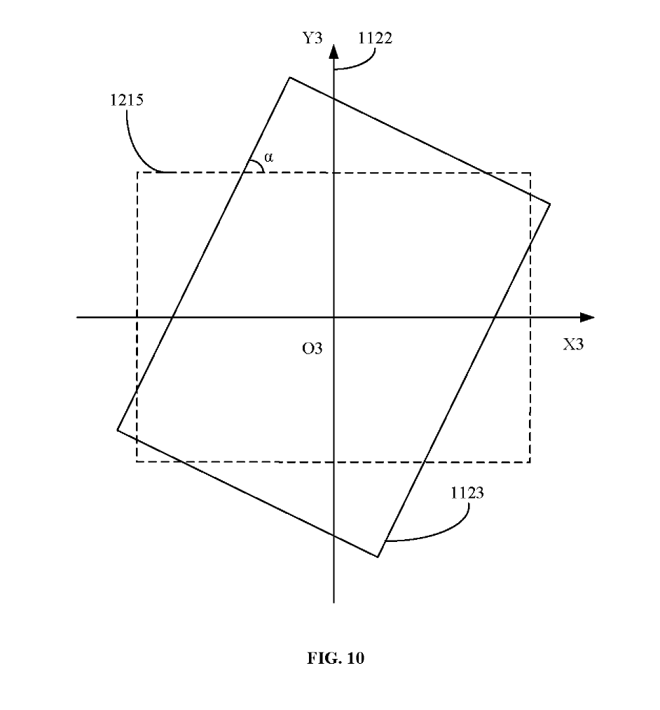

When the rotation angle α, shown in FIG. 9, of the electronic device 200 falls within the second angle range, the first coordinate defining unit 112 defines a third planar coordinate system 1122 shown in FIG. 10 on the fifth rotated user interface 1125. In at least one embodiment, an origin O3 of the third planar coordinate system 1122 is on the center of the fifth rotated user interface 1125. The axis X3 of the third planar coordinate system 1122 extends along a length direction of the fifth rotated user interface 1125. The axis Y3 of the third planar coordinate system 1122 extends along a width direction of the fifth rotated user interface 1125. The first coordinate defining unit 112 then defines a third region 1123 in the third planar coordinate system 1122. In at least one embodiment, the third region 1123 is obtained by rotating the fifth rotated user interface 1125 an angle α opposite to the rotation direction of the electronic device 200.

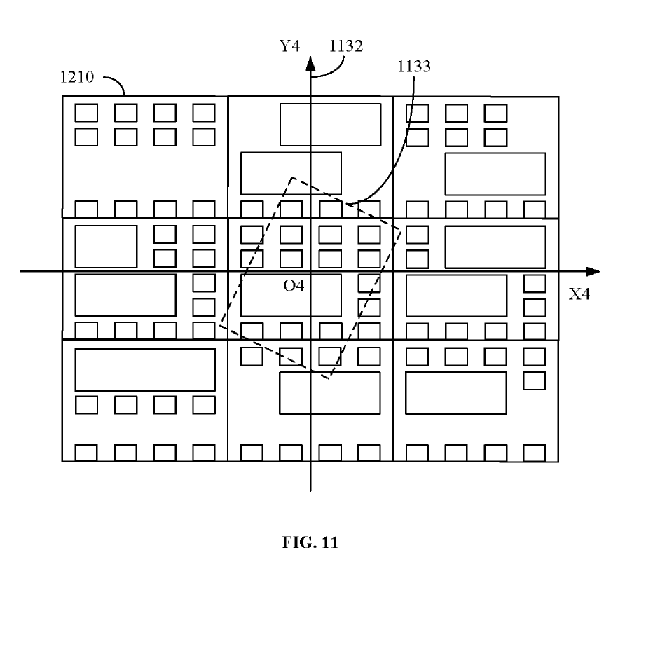

The second coordinate defining unit 113 defines a fourth planar coordinate system 1132 shown in FIG. 11 on the second rotated user interface group 1120. In at least one embodiment, an origin O4 of the fourth planar coordinate system 1132 is on the center of the fifth rotated user interface 1125. The axis X4 of the fourth planar coordinate system 1132 extends along a length direction of the fifth rotated user interface 1125. The axis Y4 of the fourth planar coordinate system 1132 extends along a width direction of the fifth rotated user interface 1125. The second coordinate defining unit 113 then defines a fourth region 1133 in the fourth planar coordinate system 1132. In at least one embodiment, the fourth region 1133 has a same size as that of the third region 1123.

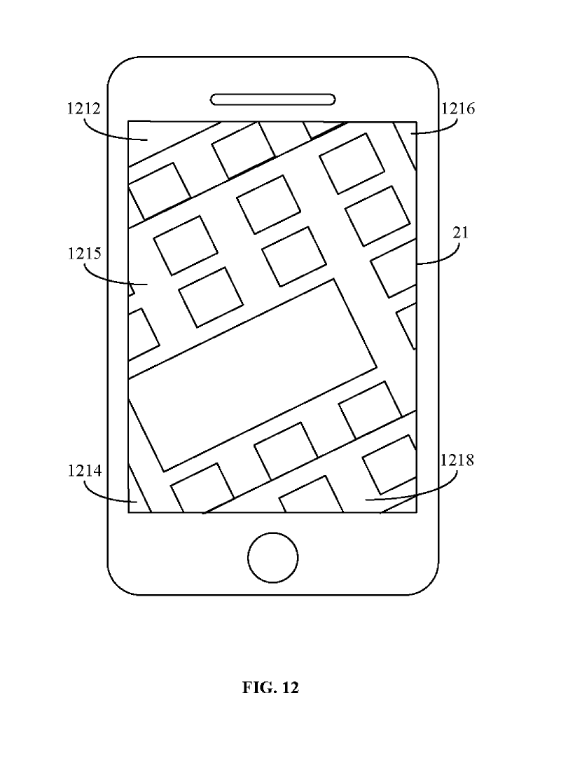

The display control unit 114 controls the display unit 21 to display content of the second rotated user interface group 1120 on the fourth region 1133 shown in FIG. 12. In at least one embodiment as shown in FIG. 12, the content can include a part of the second rotated user interface 1122, a part of the fourth rotated user interface 1124, a part of the fifth rotated user interface 1125, a part of the sixth rotated user interface 1126 and a part of the eighth rotated user interface 1128. In an alternative embodiment, the content can include part of other initial user interfaces.

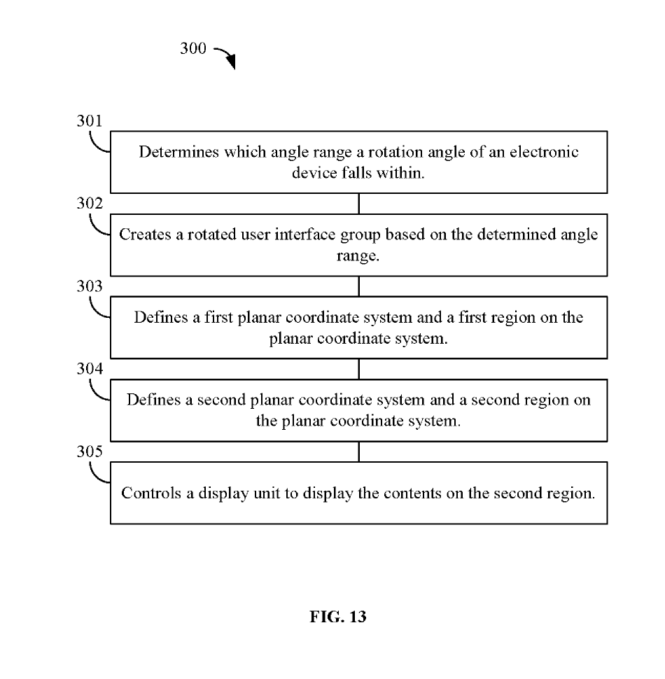

Referring to FIG. 13, a flowchart is presented in accordance with an example embodiment. A method 300 is provided by way of example, as there are a variety of ways to carry out the method. The method 300 described below can be carried out using the configurations illustrated in FIG. 1 and various elements of these figures are referenced in explaining example method 300. Each block shown in FIG. 13 represents one or more processes, methods, or routines, carried out in the exemplary method 300. Additionally, the illustrated order of blocks is by example only and the order of the blocks can be changed. The exemplary method 300 can begin at block 301.

At block 301, a determination unit determines which angle range a rotation angle of an electronic device falls within. The rotation angle is an angle between a vertical axis associated with a current position of the electronic device and a vertical axis associated with a vertical position of the electronic device.

At block 302, a rotation unit creates a rotated user interface group based on the determined angle range. In at least one embodiment, the rotation unit creates a first rotated user interface group if the rotation angle falls within a first angle range or a fifth angle range, which includes angles between 45 degrees and 135 degrees or 315 degrees and 360 degrees. In at least one embodiment, the first rotated user interface group can include a first initial user interface, a second initial user interface, a third initial user interface, a fourth initial user interface, a fifth initial user interface, a sixth initial user interface, a seventh initial user interface, an eighth initial user interface and a ninth initial user interface. Each user interface of the first rotated user interface group corresponds to an initial user interface of an initial user interface group stored in a storage unit, for example, the fourth rotated user interface corresponds to a fourth initial user interface of the initial user interface group, and the fifth rotated user interface corresponds to a fifth initial user interface. Each user interface of the rotated user interface group is obtained by rotating a corresponding initial user interface 90 degrees along a rotation direction of the electronic device.

The rotation unit creates a second rotated user interface group if the rotation angle falls within the second angle range, which includes angles between 135 degrees and 225 degrees. In at least one embodiment, the second rotated user interface group can include a first rotated user interface, a second rotated user interface, a third rotated user interface, a fourth rotated user interface, a fifth rotated user interface, a sixth rotated user interface, a seventh rotated user interface, an eighth rotated user interface and a ninth rotated user interface. Each user interface of the second rotated user interface group corresponds to an initial user interface of the initial user interface group, for example, the fourth rotated user interface corresponds to the fourth initial user interface, and the fifth rotated user interface corresponds to the fifth initial user interface. Each user interface of the second rotated user interface group is obtained by rotating a corresponding initial user interface 90 degrees along a rotation direction of the electronic device.

At block 303, a first coordinate defining unit defines a planar coordinate system and a corresponding region on the planar coordinate system. In at least one embodiment, when the rotation angle falls within the first angle range or the fifth angle range, the first coordinate defining unit defines a first planar coordinate system on a current user interface. An origin O1 of the first planar coordinate system is on the center of the current user interface. The axis X1 of the first planar coordinate system extends along a width direction of the current user interface. The axis Y1 of the first planar coordinate system extends along a length direction of the current user interface. The first coordinate defining unit then defines a first region in the first planar coordinate system. In at least one embodiment, the first region is obtained by rotating the current user interface an angle α opposite to the rotation direction of the electronic device.

When the rotation angle falls within the second angle range, the first coordinate defining unit defines a third planar coordinate system on the fifth rotated user interface. In at least one embodiment, an origin O3 of the third planar coordinate system is on the center of the fifth rotated user interface. The axis X3 of the third planar coordinate system extends along a length direction of the fifth rotated user interface. The axis Y3 of the third planar coordinate system extends along a width direction of the fifth rotated user interface. The first coordinate defining unit then defines a third region in the third planar coordinate system. In at least one embodiment, the third region is obtained by rotating the fifth rotated user interface an angle α opposite to the rotation direction of the electronic device.

At block 304, a second coordinate defining unit defines a planar coordinate system and a corresponding region on the planar coordinate system. In at least one embodiment, when the rotation angle falls within the first angle range or the fifth angle range, the second coordinate defining unit defines a second planar coordinate system on the first rotated user interface group. An origin O2 of the second planar coordinate system is on the center of the fifth initial user interface, e.g. the current user interface. The axis X2 of the second planar coordinate system extends along a width direction of the fifth initial user interface. The axis Y2 of the second planar coordinate system extends along a length direction of the fifth initial user interface. The second coordinate defining unit then defines a second region in the second planar coordinate system. In at least one embodiment, the second region has a same size as that of the first region.

When the rotation angle falls within the second angle range, the second coordinate defining unit defines a fourth planar coordinate system on the second rotated user interface group. In at least one embodiment, an origin O4 of the fourth planar coordinate system is on the center of the fifth rotated user interface. The axis X4 of the fourth planar coordinate system extends along a length direction of the fifth rotated user interface. The axis Y4 of the fourth planar coordinate system extends along a width direction of the fifth rotated user interface. The second coordinate defining unit then defines a fourth region in the fourth planar coordinate system. In at least one embodiment, the fourth region has a same size as that of the third region.

At block 305, a display control unit controls a display unit to display content of the first rotated user interface group on the corresponding region defined by the second coordinate defining unit. In at least one embodiment, when the rotation angle falls within the first angle range or the fifth angle range, the display control unit controls the display unit to display the contents on the second region. In at least one embodiment, the content can include a part of the second initial user interface, a part of the fourth initial user interface, a part of the fifth initial user interface, a part of the sixth initial user interface and a part of the eighth initial user interface. In an alternative embodiment, the content can include part of other user interfaces.

When the rotation angle falls within the second angle range, the display control unit controls the display unit to display the contents on the fourth region. In at least one embodiment, the contents can include a part of the second rotated user interface, a part of the fourth rotated user interface, a part of the fifth rotated user interface, a part of the sixth rotated user interface and a part of the eighth rotated user interface. In an alternative embodiment, the content can include part of other user interfaces.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A control system for controlling user interfaces on an electronic device, the control system comprising a plurality of units stored in a storage unit and being executed by a processor to:
determine whether a rotation angle of the electronic device is within an angle range among a plurality of angle ranges stored in the storage unit;
create a rotated user interface group comprising a plurality of rotated user interfaces based on the rotation angle of the electronic device and an initial user interface, wherein each rotated user interface of the rotated user interface group corresponds to an initial user interface of an initial user interface group stored in the storage unit;
create a first planar coordinate system on a rotated user interface of the rotated user interface group;
define a first region obtained by rotating the rotated user interface the rotation angle of the electronic device;
create a second planar coordinate system on the rotated user interface group;
define a second region which has a same size as that of the first region; and
display content of the rotated user interface group on the second region.

2. The control system of claim 1, wherein the control system further comprising a plurality of units stored in the storage unit which can be executed by the processor to:
create a first rotated user interface group comprising a plurality of rotated user interfaces, which have the same number and content as the initial user interface group, when the rotation angle of the electronic device is in a first angle range which comprises angles between 0 degrees and 45 degrees or a second angle range which comprises angles between 315 degree and 360 degrees;
create a second rotated user interface group comprising a plurality of rotated user interfaces when the rotation angle of the electronic device is in a third angle range which comprises angles between 45 degrees and 135 degrees, wherein each rotated user interface of the second rotated user interface group corresponds to an initial user interface of the initial user interface group, and is obtained by rotating a corresponding initial user interface 90 degrees;
create a third rotated user interface group comprising a plurality of rotated user interfaces when the rotation angle of the electronic device is in a fourth angle range which comprises angles between 135 degrees and 225 degrees, wherein each rotated user interface of the third rotated user interface group corresponds to an initial user interface of the initial user interface group, and is obtained by rotating a corresponding initial user interface 180 degrees; and
create a fourth rotated user interface group comprising a plurality of rotated user interfaces when the rotation angle of the electronic device is in a fifth angle range which comprises angles between 225 degrees and 315 degrees, wherein each rotated user interface of the fourth rotated user interface group corresponds to an initial user interface of the initial user interface group, and is obtained by rotating a corresponding initial user interface 270 degrees.

3. The control system of claim 1, wherein an origin O1 of the first planar coordinate system is on the center of the rotated user interface; the axis X1 of the first planar coordinate system extends along a width direction of the rotated user interface; the axis Y1 of the first planar coordinate system extends along a length direction of the rotated user interface.

4. The control system of claim 3, wherein an origin O2 of the second planar coordinate system is on the center of the rotated user interface; the axis X2 of the second planar coordinate system extends along a width direction of the rotated user interface; the axis Y2 of the second planar coordinate system extends along a length direction of the rotated user interface.

5. The control system of claim 1, wherein the angle between the rotated user interface and the first region is opposite to a rotation direction of the electronic device.

6. A control method for controlling user interfaces on an electronic device, the control method comprising:
executing a plurality of units stored in a storage unit by a processor for:
determining whether a rotation angle of the electronic device falls within an angle range among a plurality of angle ranges stored in the storage unit;
creating a rotated user interface group comprising a plurality of rotated user interfaces based on the rotation angle of the electronic device and an initial user interface, wherein each rotated user interface of the rotated user interface group corresponds to an initial user interface of an initial user interface group stored in the storage unit;
creating a first planar coordinate system on a rotated user interface of the rotated user interface group;
defining a first region obtained by rotating the rotated user interface an angle of the rotation angle of the electronic device;
creating a second planar coordinate system on the rotated user interface group;
defining a second region which has a same size as that of the first region; and
displaying content of the rotated user interface group on the second region.

7. The control method of claim 6, wherein the control method further comprising a plurality of units stored in the storage unit which can be executed by the processor for:
creating a first rotated user interface group comprising a plurality of rotated user interfaces, which have the same number and content as the initial user interface group, when the rotation angle of the electronic device is in a first angle range which comprises angles between 0 degrees and 45 degrees or a second angle range which comprises angles between 315 degrees and 360 degrees;
creating a second rotated user interface group comprising a plurality of rotated user interfaces when the rotation angle of the electronic device is in a third angle range which comprises angles between 45 degrees and 135 degrees, wherein each rotated user interface of the second rotated user interface group corresponds to an initial user interface of the initial user interface group, and is obtained by rotating a corresponding initial user interface 90 degrees;
creating a third rotated user interface group comprising a plurality of rotated user interfaces when the rotation angle of the electronic device is in a fourth angle range which comprises angles between 135 degrees and 225 degrees, wherein each rotated user interface of the third rotated user interface group corresponds to an initial user interface of the initial user interface group, and is obtained by rotating a corresponding initial user interface is rotated 180 degrees; and
creating a fourth rotated user interface group comprising a plurality of rotated user interfaces when the rotation angle of the electronic device is in a fifth angle range which comprises angles between 225 degrees and 315 degrees, wherein each rotated user interface of the fourth rotated user interface group corresponds to an initial user interface of the initial user interface group, and is obtained by rotating a corresponding initial user interface 270 degrees.

8. The control method of claim 6, wherein creating a first planar coordinate system on a rotated user interface of the rotated user interface group comprising:
creating an origin O1 on the center of the rotated user interface;
creating an axis X1 along a width direction of the rotated user interface; and
creating an axis Y1 along a length direction of the rotated user interface.

9. The control method of claim 8, wherein creating a second planar coordinate system on the rotated user interface group comprising:
creating an origin O2 on the center of the rotated user interface;
creating an axis X2 along a width direction of the rotated user interface; and
creating an axis Y2 along a length direction of the rotated user interface.
